(19) United States
(12) Patent Application Publication
(10) Pub. No.: US 2023/0159304 A1
(43) Pub. Date: May 25, 2023

(54) LIFTING HOOK

(71) Applicant: ULMA C y E, S. Coop, OÑATI (ES)

(72) Inventor: Abel ERCILLA LECEA, VITORIA-GASTEIZ (ES)

(21) Appl. No.: 17/991,917

(22) Filed: Nov. 22, 2022

(30) Foreign Application Priority Data
Nov. 23, 2021 (EP) 21383054.0

(51) Int. Cl. B66C 1/36; E04G 19/00; B66C 1/44

(52) U.S. Cl. CPC B66C 1/36; E04G 19/003; B66C 1/442

(57) ABSTRACT

A lifting hook including a fixed portion and a moving portion coupled to the fixed portion, the moving portion being pivotable between a locking position in which the moving portion retains a profile of a formwork panel housed in a housing of the fixed portion, and a release position in which the profile of the formwork panel can be introduced into or extracted from the housing. The lifting hook also includes a pushing part coupled to the fixed portion which pushes the moving portion when the pushing part is pulled.

### CROSS-REFERENCE TO RELATED APPLICATIONS

This application relates to and claims the benefit and priority to European Application No. 21383054.0, filed Nov. 23, 2021.

### FIELD

The present invention relates to a lifting hook, with a method of lifting by means of the lifting hook, and with a formwork assembly incorporating the lifting hook.

### BACKGROUND

The use of vertical formworks for building vertical structures, such as walls, for example, is known. A vertical formwork comprises two formwork panels arranged facing one another and fixed together by means of a tie rod.

The use of lifting hooks for lifting the formwork panels by means of a crane is also known.

For example, there are known lifting hooks comprising a fixed portion comprising a housing configured for housing a profile of a formwork panel, and a moving portion coupled to the fixed portion and pivotable between a locking position in which the moving portion retains the profile of a formwork panel housed in the housing of the fixed portion, and a release position in which the profile of a formwork panel can be introduced into or extracted from the housing of the fixed portion.

With respect to the uncoupling of this type of lifting hooks from the corresponding formwork panel, on one hand conventional lifting hooks which are uncoupled from the respective formwork panel by an operator acting directly on the moving portion are known.

On the other hand, remote lifting hooks which can be uncoupled from the formwork panel remotely, i.e., the operator does not have to act directly on the moving portion of the hook, but rather acts on the moving portion by means of an intermediate element, avoiding having to go up to the height at which the hook is arranged, are known. For example, EP24248108A1 relates to a lifting hook of this type, in which the moving portion comprises an extension configured for being coupled to a rod, such that the operator can pivot the moving portion by pushing the extension of the moving portion with the rod.

### SUMMARY

Provided is a lifting hook, a method of lifting by means of the lifting hook and a formwork assembly incorporating the lifting hook, as defined in the claims.

A first aspect relates to a lifting hook for lifting formwork panels.

The lifting hook comprises a fixed portion and a moving portion coupled in a pivotable manner with respect to a pivoting shaft to the fixed portion. The fixed portion comprises a housing configured for housing a profile of a formwork panel.

The moving portion is pivotable between a locking position in which the moving portion retains the profile of the formwork panel housed in the housing of the fixed portion, and a release position in which the profile of the formwork panel can be introduced into or extracted from the housing of the fixed portion. The moving portion is movable to the release position when a release area of the moving portion is pushed.

The lifting hook also comprises a pushing part coupled to the fixed portion which pushes the release area of the moving portion when the pushing part is pulled. Furthermore, the lifting hook comprises a pulling element coupled to the pushing part so that an operator can pull the pulling element in order to pull the pushing part.

The lifting hook of the invention offers an alternative configuration for being able to uncouple the lifting hook from the corresponding formwork panel remotely.

Using the pushing part as an intermediate part between the moving portion and the operator, and therefore not acting directly on the moving portion of the hook, offers two important advantages. First, by not acting directly on the moving portion but rather on an additional part, it allows conventional lifting hooks (those which cannot be uncoupled from the formwork panel remotely) to be adapted by coupling a pushing part to the fixed portion. Conventional lifting hooks can thereby be transformed into remote lifting hooks in a simple manner. Second, the fact that the action to be performed by the operator is to pull the pushing element instead of having to push a specific area of the moving portion of the lifting hook with a rod considerably facilitates the operator's work. The distance at which the operator of the lifting hook can be located can range between 2 m and 8 m, and therefore it may be difficult to hit the specific area of the moving portion with the rod. Furthermore, in the lifting hook of the state of the art, the operator having to push the moving portion requires using a rigid element, and a rigid element of that length may be hard to manage.

A second aspect relates to a method of lifting by means of a lifting hook such as the one described above.

The method of lifting of the invention comprises the following steps: (1) a first step of securing the formwork panel in which a profile of the formwork panel is housed in the fixed portion of the lifting hook, and the moving portion of the lifting hook is arranged in the locking position, (2) a second step of lifting the formwork panel in which the formwork panel is lifted moving the lifting hook by means of a crane, the formwork panel being arranged in a final position in which the lifting hook is in a lifted position, and (3) a third step of disengaging the lifting hook in which an operator moves the lifting hook to the release position by pulling the pulling element coupled to the pushing part of the lifting hook from a position arranged below the lifted position in which the lifting hook is located.

A third aspect relates to a vertical formwork assembly comprising a lifting hook such as the one described above.

These and other advantages and features become apparent in view of the figures and the detailed description.

### BRIEF DESCRIPTION OF THE DRAWINGS

FIG. 1 shows a perspective view of a lifting hook according to one embodiment.

FIG. 2 shows a second perspective view of the lifting hook of FIG. 1.

FIG. 3 shows a partial view of the lifting hook of FIG. 1 in which part of the fixed portion has been removed, the moving portion being arranged in the locking position.

FIG. 4 shows a partial view of the lifting hook of FIG. 1 in which part of the fixed portion has been removed, the moving portion being arranged in the release position.

FIG. 5 shows a partial view of a formwork assembly comprising a lifting hook such as the one in FIG. 1.

### DETAILED DESCRIPTION

A first aspect relates to a lifting hook configured for lifting formwork panels.

The lifting hook 1 comprises a fixed portion 2 and a moving portion 3 coupled in a pivotable manner to the fixed portion 2, the moving portion 3 being pivotable with respect to a pivoting shaft 32 between a locking position and a release position.

The fixed portion 2 comprises a housing 20 configured for housing a profile 70 of a formwork panel 7.

When the moving portion 3 is arranged in the locking position, it retains the profile 70 of a formwork panel 7 housed in the housing 20 of the fixed portion 2. Preferably, the moving portion 3 comprises a locking surface 30 configured for retaining the profile 70 of a formwork panel 7 housed in the housing 20 of the fixed portion 2 when the moving portion 3 is arranged in the locking position.

When the moving portion 3 is arranged in the release position, the profile 70 of a formwork panel 7 can be introduced into or extracted from the housing 20 of the fixed portion 2.

The moving portion 3 is movable to the release position by pushing a release area 33 of the moving portion 3.

The lifting hook 1 also comprises a pushing part 4 coupled to the fixed portion 2 which pushes the release area 33 of the moving portion 3 when the pushing part 4 is pulled, and a pulling element 6 coupled to the pushing part 4 so that an operator can pull the pulling element 6 in order to pull the pushing part 4.

Therefore, when the moving portion 3 is arranged in the locking position and an operator pulls the pulling element 6 which in turn pulls the pushing part 4, the pushing part 4 pushes the release area 33, such that the moving portion 3 pivots with respect to the fixed portion 2 and transitions from the locking position to the release position.

Using the pushing part 4 as an intermediate part between the moving portion 3 and the operator, and therefore not acting directly on the moving portion 3 of the lifting hook 1, offers two important advantages. First, by not acting directly on the moving portion 3 but rather on an additional part, it allows conventional lifting hooks to be transformed and reused as remote lifting hooks 1 by coupling a pushing part 4 to the fixed portion 2. Second, the fact that the action to be performed by the operator is to pull instead of having to push a specific area of the moving portion of the lifting hook with a rod considerably facilitates the operator's work.

The pulling element 6 can be a cord, a cable, a strap, a chain, or any other element that can be coupled to the pushing part 4 and is suitable for being handled by the operator such that upon pulling the pulling element 6, the latter pulls the pushing part 4. Optionally, the pushing part and the pulling element can be an integral part.

According to one embodiment, the pushing part 4 is coupled in a pivotable manner to the fixed portion 2 by means of a pivoting shaft 40, the pushing part 4 being able to pivot between a standby position and a release position. In this manner, should it be desirable to transform a conventional lifting hook into a remote lifting hook, all that would have to be made is a hole in the fixed portion to be able to couple the pushing part. Preferably, the pushing part 4 is a cam, although it can have other forms as well, for example a flat bar.

According to one embodiment, the pushing part 4 comprises a handling portion 41 and a pushing portion 42 configured for pushing the release area 33 of the moving portion 3, the handling portion 41 extending to one side of the pivoting shaft 40 and the handling portion 41 extending to the other side of the pivoting shaft 40. Therefore, when the moving portion 3 is arranged in the locking position and the pushing part 4 is arranged in the standby position and the handling portion 41 of the pushing part 4 is pulled, the pushing part 4 pivots with the pushing portion 42 of the pushing part 4 pushing the release area 33 of the moving portion 3, such that the moving portion 3 pivots with respect to the fixed portion 2 and transitions from the locking position to the release position when the pushing part 4 pivots from the standby position to the pushing position.

According to one embodiment, the handling portion 41 is configured for being coupled to the pulling element 6, such that when the pushing part 4 is arranged in the standby position and an operator pulls the pulling element 6, the pushing part 4 pivots from the standby position to the pushing position, with the pushing portion 42 pushing the release area 33 of the moving portion 3, the moving portion 3 transitioning from the locking position to the release position. More preferably, a coupling shackle 43 is coupled to the handling portion 41, the pulling element 6 being coupled to the coupling shackle 43. Optionally the pulling element 6 is detachably coupled to the coupling shackle 43; in this manner, for example should it be desirable to use the lifting hook 1 in a conventional manner, i.e., without the option of being remotely uncoupled, the pulling element 6 can be removed from the lifting hook 1.

According to one embodiment, the moving portion 3 comprises a shackle 31 configured for being coupled to a sling 5 through which the force needed to lift the corresponding formwork panel 7 is applied. The shackle 31 is arranged with respect to the pivoting shaft 32 such that upon applying a lifting force on the shackle 31, the moving portion 3 is forced to the locking position such that the moving portion 3 will be securely arranged at all times in the locking position when a formwork panel 7 is being lifted.

According to one embodiment, the fixed portion 2 comprises a first side plate 22a and a second side plate 22b facing and attached to one another, the moving portion 3 being arranged between the side plates 22a and 22b, and the pushing part 4 being arranged coupled to the inner face of the first side plate 22a. In this manner, as discussed above, preferably simply making a hole in one of the side plates 22a is enough to couple the pushing part 4 to the fixed portion 2 for transforming a conventional lifting hook into a remote lifting hook.

According to one embodiment, each side plate 22a, 22b comprises a hook 21a, 21b configured for being housed in the channel 71 of a profile 70 of a formwork panel 7 when the profile 70 is arranged housed in the housing 20 of the fixed portion 2.

According to one embodiment, the lifting hook comprises a coil spring biasing the moving portion 3 to the locking position.

A second aspect of the relates to a method of lifting a formwork panel 7 by means of a lifting hook 1 such as the one described above. The method of lifting comprises the following steps: (1) a first step of securing the formwork panel 7 in which a profile 70 of the formwork panel 7 is housed in the fixed portion 2 of the lifting hook 1, and the moving portion 3 of the lifting hook 1 is arranged in the locking position, (2) a second step of lifting the formwork panel 7 in which the formwork panel 7 is lifted moving the lifting hook 1 by means of a crane, the formwork panel 7 being arranged in a final position in which the lifting hook 1 is in a lifted position, and (3) a third step of disengaging the lifting hook 1 in which an operator moves the lifting hook 1 to the release position by pulling the pulling element 6 coupled to the pushing part 4 of the lifting hook 1 from a position arranged below the lifted position in which the lifting hook 1 is located.

A third aspect relates to a vertical formwork assembly comprising at least one formwork panel 7 comprising a profile 70, and a lifting hook 1 such as the one described above. Preferably, the profile 70 of the formwork panel 7 comprises a channel 71 in which the hooks 21a and 21b of the fixed portion 2 are arranged when the profile 70 of the formwork panel 7 is arranged housed in the housing 20 of the fixed portion 2 of the lifting hook 1.

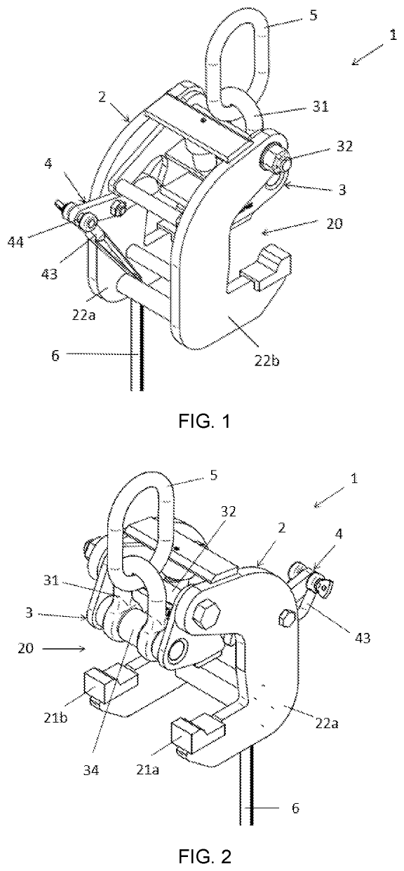

FIGS. 1 and 2 show an embodiment of the lifting hook 1.

The lifting hook 1 comprises a fixed portion 2 and a moving portion 3 coupled in a pivotable manner to the fixed portion 2, the moving portion 3 being able to pivot with respect to a pivoting shaft 32 between a locking position and a release position. The fixed portion 2 comprises a housing 20 configured for housing a profile 70 of a formwork panel 7, and the moving portion 3 comprises a locking surface 30 configured for retaining the profile 70 of a formwork panel 7 housed in the housing 20 of the fixed portion 2 when the moving portion 3 is arranged in the locking position.

The lifting hook 1 also comprises a pushing part 4 and a pulling element 6 coupled to the pushing part 4.

The pushing part 4 of the lifting hook 1 of this embodiment is a cam coupled in a pivotable manner to the fixed portion 2 by means of a pivoting shaft 40, the pushing part 4 being able to pivot between a standby position and a release position. The pushing part 4 comprises a handling portion 41 and a pushing portion 42 configured for pushing a release area 33 of the moving portion 3, the handling portion 41 extending to a side of the pivoting shaft 40 and the handling portion 42 extending to the other side of the pivoting shaft 40.

In this embodiment, the handling portion 41 of the pushing part is coupled to the pulling element 6, such that the operator acts on the pushing part 4 through the pulling element 6. Therefore, when the pushing part 4 is arranged in the standby position and an operator pulls the pulling element 6, the pushing part 4 pivots from the standby position to the pushing position. In this embodiment, pulling element 6 is coupled to the handling portion 41 by means of a coupling shackle 43 which is coupled to the handling portion 41 by means of a coupling shaft 44, pulling element 6 being coupled to the coupling shackle 43. The pulling element 6 of the lifting hook 1 of this embodiment is a strap.

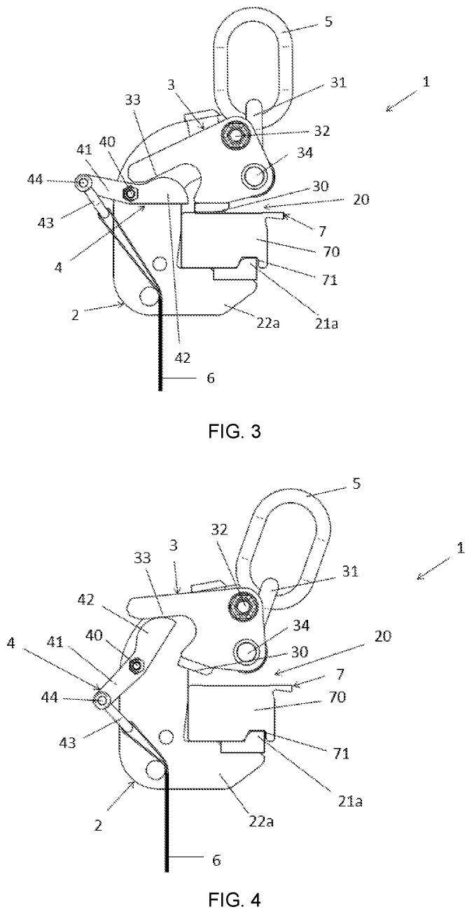

FIG. 3 shows the moving portion 3 arranged in the locking position and the pushing part 4 arranged in the standby position. As shown in this figure, when the profile 70 of a formwork panel 7 is housed in the housing 20 of the fixed portion 2 and the moving portion 3 is arranged in the locking position, the locking surface 30 abuts with an upper surface of the profile 70 of the formwork panel 7, the formwork panel 7 being retained inside the housing 20 of the fixed portion 2.

FIG. 4 shows the moving portion in the release position and the pushing part 4 in the pushing position. As is shown in this figure, when the moving portion 3 is arranged in the release position, the profile 70 of a formwork panel 7 can be introduced into or extracted from the housing 20 of the fixed portion 2.

In this embodiment, the fixed portion 2 comprises a first side plate 22a and a second side plate 22b facing and attached to one another by means of a plurality of transverse elements. Each side plate 22a, 22b comprises a hook 21a, 21b configured for being housed in a channel 71 of a profile 70 of a formwork panel 7 when the profile 70 is arranged housed in the housing 20 of the fixed portion 2. The moving portion 3 is arranged between the side plates 22a and 22b. Furthermore, the pushing part 4 is coupled to the inner face of the first side plate 22a. To that end, the first side plate 22a comprises a hole in which the pivoting shaft 41 of the pushing part 4 is coupled.

In this embodiment, the moving portion 3 comprises a shackle 31 configured for being coupled to a sling 5 through which the force needed to lift the corresponding formwork panel 7 is applied. The shackle 31 is arranged with respect to the pivoting shaft 32 such that upon applying a lifting force on the shackle 31, the moving portion 3 is forced to the locking position such that the moving portion 3 will be securely arranged at all times in the locking position when a formwork panel 7 is being lifted.

In this embodiment, the lifting hook 1 comprises a coil spring (not shown in the figures) biasing the moving portion 3 to the locking position.

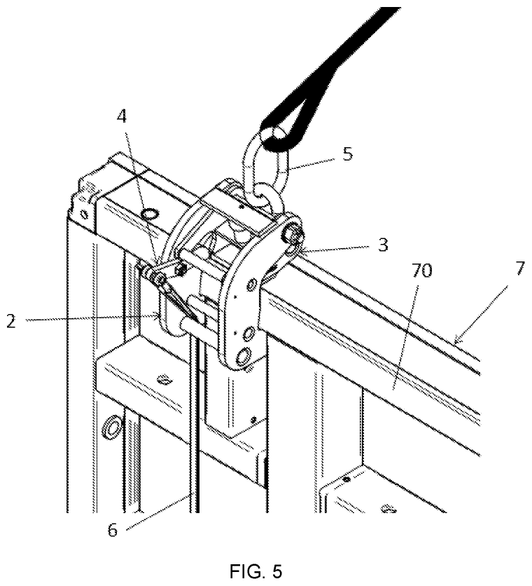

FIG. 5 shows a vertical formwork assembly comprising a formwork panel 7 comprising a profile 70 and a lifting hook 1 of the preferred embodiment, the lifting hook 1 being in the locking position. The profile 70 of the formwork panel 7 comprises a channel 71 in which the hooks 21a and 21b of the fixed portion 2 are arranged when the profile 70 of the formwork panel 7 is arranged housed in the housing 20 of the fixed portion 2 of the lifting hook.

The following clauses further disclose one or more additional embodiments.

Clause 1. Lifting hook configured for lifting formwork panels, comprising

a fixed portion (2) comprising a housing (20) configured for housing a profile (70) of a formwork panel (7), and

a moving portion (3) coupled to the fixed portion (2), the moving portion (3) being pivotable with respect to a pivoting shaft (32) between
a locking position in which the moving portion (3) retains the profile (70) of the formwork panel (7) housed in the housing (20) of the fixed portion (2), and
a release position in which the profile (70) of the formwork panel (7) can be introduced into or extracted from the housing (20) of the fixed portion (2), the moving portion (3) being movable to the release position by pushing a release area (33) of the moving portion (3),
the lifting hook comprises a pushing part (4) coupled to the fixed portion (2) which pushes the release area (33) of the moving portion (3) when the pushing part (4) is pulled, and a pulling element (6) coupled to the pushing part (4) so that an operator can pull the pulling element (6) in order to pull the pushing part (4).

Clause 2. Lifting hook according to clause 1, wherein the pulling element (6) is a cord, a cable, a strap or a chain.

Clause 3. Lifting hook according to clause 1 or 2, wherein the pushing part (4) is pivotable with respect to the fixed portion (2) by means of a pivoting shaft (40).

Clause 4. Lifting hook according to clause 3, wherein the pushing part (4) is a cam.

Clause 5. Lifting hook according to any of clauses 2 to 4, wherein the pushing part (4) comprises a handling portion (41) and a pushing portion (42) configured for pushing the release area (33) of the moving portion (3), the handling portion (41) extending to one side of the pivoting shaft (40) and the handling portion (42) extending to the other side of the pivoting shaft (40).

Clause 6. Lifting hook according to clause 5, wherein the handling portion (41) is configured for being coupled to the pulling element (6), such that when the pushing part (4) is arranged in the standby position and an operator pulls the pulling element (6), the pushing part (4) pivots from the standby position to the pushing position, with the pushing portion (42) pushing the release area (33) of the moving portion (3).

Clause 7. Lifting hook according to any of the preceding clauses, wherein the moving portion (3) comprises a locking surface (30) configured for retaining the profile (70) of the formwork panel (7) housed in the housing (20) of the fixed portion (2) when the moving portion (3) is arranged in the locking position.

Clause 8. Lifting hook according to any of the preceding clauses, wherein the moving portion (3) comprises a shackle (31) configured for being coupled to a sling (5), the shackle (31) being arranged with respect to the pivoting shaft (32) such that upon applying a lifting force on the shackle (31), the moving portion (3) is forced to the locking position.

Clause 9. Lifting hook according to any of the preceding clauses, wherein the fixed portion (2) comprises a first side plate (22a) and a second side plate (22b) facing and attached to one another, the moving portion (3) being arranged between the side plates (22a, 22b), and the pushing part (4) being arranged coupled to the inner face of the first side plate (22a).

Clause 10. Lifting hook according to clause 9, wherein each side plate (22a, 22b) comprises a hook (21a, 21b) configured for being housed in the channel (71) of the profile (70) of the formwork panel (7) when the profile (70) is arranged housed in the housing (20) of the fixed portion (2).

Clause 11. Lifting hook according to any of the preceding clauses, comprising a coil spring biasing the moving portion (3) to the locking position.

Clause 12. Method of lifting a formwork panel by means of a lifting hook according to any of the preceding clauses, the method comprising the following steps:
a first step of securing the formwork panel (7) in which a profile (70) of the formwork panel (7) is housed in the fixed portion (2) of the lifting hook (1), and the moving portion (3) of the lifting hook (1) is arranged in the locking position,
a second step of lifting the formwork panel (7) in which the formwork panel (7) is lifted moving the lifting hook (1) by means of a crane, the formwork panel (7) being arranged in a final position in which the lifting hook (1) is in a lifted position, and
a third step of disengaging the lifting hook (1) in which an operator moves the lifting hook (1) to the release position by pulling the pulling element (6) coupled to the pushing part (4) of the lifting hook (1) from a position arranged below the lifted position in which the lifting hook (1) is located.

Clause 13. Vertical formwork assembly comprising at least one formwork panel (7) comprising a profile (70), and a lifting hook (1) according to any of clauses 1 to 11.

What is claimed is:

1. A lifting hook for lifting a formwork panel, the lifting hook comprising:
a fixed portion that includes a housing configured to house a profile of the formwork panel;
a moving portion coupled to the fixed portion, the moving portion being pivotable between a locking position and a release position, in the locking position the moving portion retains the profile housed in the housing of the fixed portion, in the release position the profile can be introduced into or extracted from the housing of the fixed portion; and
a pushing part pivotably coupled to the fixed portion and including a handling portion coupled to a pushing portion, the pushing part being configured to cause the pushing portion to push against the release area of the moving portion when the handling portion is pulled to cause the moving portion to transition from the locking position to the release position.

2. The lifting hook according to claim 1, further comprising a pulling element coupled to the handling portion of the pushing part.

3. The lifting hook according to claim 2, wherein the pulling element is flexible.

4. The lifting hook according to claim 3, wherein the pulling element comprises an element selected from the group consisting of a cord, a cable, a strap and a chain.

5. The lifting hook according to claim 1, wherein a first shaft extends through a part of the fixed portion and a part of the moving portion, the moving portion being pivotable with respect to the fixed part by means of the first shaft.

6. The lifting hook according to claim 1, wherein a second shaft extends through a part of the pushing part and a part of the fixed portion, the pushing part being pivotable with respect to the fixed portion by means of the second shaft.

7. The lifting hook according to claim 5, wherein a second shaft extends through a part of the pushing part and a part of the fixed portion, the pushing part being pivotable with respect to the fixed portion by means of the second shaft.

8. The lifting hook according to claim 1, wherein the pushing portion is a cam.

9. The lifting hook according to claim 7, wherein the pushing portion is a cam.

10. The lifting hook according to claim 6, wherein the handling portion is located on a first side of the second shaft and the pushing portion is located on a second side of the shaft opposite the first side of the second shaft.

11. The lifting hook according to claim 1, wherein the moving portion includes a locking surface that pushes against the profile of the formwork when the moving portion is in the locking position.

12. The lifting hook according to claim 5, wherein the moving portion comprises a shackle configured to be coupled to a sling, the shackle being arranged with respect to the first shaft such that upon a lifting force being applied to the shackle, the moving portion is forced towards the locking position.

13. The lifting hook according to claim 1, wherein the fixed portion includes a first side plate and a second side plate facing and coupled to one another, the moving portion being arranged between the first and second side plates.

14. The lifting hook according to claim 13, the pushing part is coupled to a face of one of the first and second side plates.

15. The lifting hook according to claim 13, wherein each of the first and second side plates includes a hook configured to being housed in a channel of the profile of the formwork panel when the profile is arranged housed in the housing of the fixed portion.

16. The lifting hook according to claim 1, comprising a coil spring biasing the moving portion towards the locking position.

17. A method of lifting a formwork panel by means of the lifting hook according to claim 1, the method comprising:
introducing a profile of the formwork panel into the housing of the fixed part while the moving part is in the released position with the handling portion of the pushing part being pulled;
securing the profile of the formwork panel inside the housing by releasing the handling portion of the part to cause the moving part to transition to the locked position;
lifting the lifting hook by means of a crane to cause the formwork panel to assume a lifted position; and
moving the formwork panel from a first location to a second location using the crane;
extracting the formwork panel from the housing of the fixed part upon the formwork panel being in the second location by pulling on the handling part of the pushing part to cause the moving part to assume the release position.

18. The method according to claim 17, wherein a flexible pulling element is coupled to the handling portion of the pushing part, the pulling on the handling part be achieved by a pulling on the flexible pulling element.

19. The method according to claim 18, wherein the lifting hook is configured such that a weight of the formwork panel, while the lifting hook is being lifted, assists in maintaining the moving part in the locking position.
